(19) United States
(12) Patent Application Publication
(10) Pub. No.: US 2021/0301921 A1
(43) Pub. Date: Sep. 30, 2021

(54) SHIFT APPARATUS

(71) Applicant: HONDA MOTOR CO., LTD., Tokyo (JP)

(72) Inventors: Hiroki KIMURA, Saitama (JP); Satoshi KONO, Saitama (JP); Fumitaka ABE, Saitama (JP); Yuki HONZAWA, Tokyo (JP)

(21) Appl. No.: 17/209,180

(22) Filed: Mar. 22, 2021

(30) Foreign Application Priority Data
Mar. 30, 2020 (JP) 2020-061189

(51) Int. Cl. F16H 61/12; F16H 59/08

(52) U.S. Cl. CPC F16H 61/12; F16H 59/08; F16H 2061/1216; F16H 2061/1284; F16H 2059/081

(57) ABSTRACT

To provide a shift apparatus capable of preventing a vehicle from entering a different travel state even when a state in which a range position cannot be identified occurs due to the range position being set between ranges or due to a fault. A shift apparatus of a vehicle, the shift apparatus including: a shift member that is enabled to switch to any of a plurality of predetermined ranges by performing a rotation operation of a dial-type operation member; and range position detection means configured to detect a predetermined range position of the shift member; wherein, if a state in which the range position cannot be detected continues for a predetermined time or more, notification means is operated irrespective of the rotation operation.

This application is based on and claims the benefit of priority from Japanese Patent Application 2020-061189, filed on 30 Mar. 2020, the content of which is incorporated herein by reference.

### BACKGROUND OF THE INVENTION

### Field of the Invention

The present invention relates to a shift apparatus for switching a range of a transmission mounted on a vehicle and, in particular, to a shift apparatus provided with means configured to, when a shift position is not set, notify a user thereof.

### Related Art

A shift apparatus that is provided near a display panel in front of a driver or a travel operation handle in a vehicle and is capable of switching a range by a rotation operation has been conventionally known. It is also possible to, when any range of the shift apparatus is selected, provide a click feeling to cause it to be recognized that the range is entered.

In Japanese Unexamined Patent Application, Publication No. 2013-47074, a shift apparatus is described in which selection among shift ranges that a driver can switch to by one operation is restricted so that shift range switching that is not intended by the driver can be avoided from being performed.

Patent Document 1: Japanese Unexamined Patent Application, Publication No. 2013-47074

### SUMMARY OF THE INVENTION

Even in such a shift apparatus that provides a click feeling when any range is selected, however, a case where a position between ranges where a click feeling does not occur yet is selected, due to a wrong operation or a case where a range position cannot be identified due to a fault of the shift apparatus may occur. In the shift apparatus of Japanese Unexamined Patent Application, Publication No. 2013-47074, in range switching in a range where selection of a shift range is not restricted, the case where a range position is set between ranges due to a fault or the like, and the range position cannot be identified may also occur. In the state in which a range position cannot be identified because the range position is set between ranges, a vehicle does not recognize the shift operation by a driver even though the driver has performed the operation, and the vehicle enters a different travel state.

The present invention has been devised to solve such a problem included in the conventional technique, and an object is to prevent a vehicle to enter a different travel state even when a state in which a range position cannot be identified occurs due to the range position being set between ranges or due to a fault.

In order to solve such a problem, in the present invention, there is provided a shift apparatus of a vehicle, the shift apparatus including: a shift member that is enabled to switch to any of a plurality of predetermined ranges by performing a rotation operation of a dial-type operation member; and range position detection means configured to detect a predetermined range position of the shift member; in which, if a state in which the range position cannot be detected continues for a predetermined time or more, notification means is operated irrespective of the rotation operation.

According to this configuration, if the state in which a range position cannot be detected continues for the predetermined time or more, the notification means is operated irrespective of an operation of a driver, and, thereby, the driver can recognize that the shift operation has not been accepted.

In this case, in the present invention, if, when a power source of a vehicle is switched to on from off first, the state in which a range position cannot be detected continues for the predetermined time or more after the predetermined range position is detected, the notification means is operated irrespective of the rotation operation.

When the power source of the vehicle is turned on from off, there is a possibility that the range position cannot be identified immediately after the power source of the vehicle is turned on because of influence of the dial having been operated while the power source of the vehicle was off or influence of the vehicle battery itself having been removed. If the notification means is operated even in such a case, it is annoying to the driver. Therefore, when the power source of the vehicle is turned on from off, the control to cause the notification means to operate is re-started if the state in which a range position cannot be detected continues for the predetermined time or more, after a predetermined range position is determined.

Further, in this case, in the present invention, the notification means operates until a range position of the vehicle and a range position of the shift member become the same.

By this configuration, it is possible to, when the range position of the vehicle and the range position of the shift member are different from each other, cause the notification means to operate so as to cause the driver to recognize that a shift operation has not been accepted, and it is possible to prevent unnecessary operation of the notification means after the range position of the vehicle and the range position of the shift member become the same.

Further, in this case, in the present invention, when the power source of the vehicle is turned on from off, the range position of the shift member is set as the range position of the vehicle.

By this configuration, even in a case where the power source of the vehicle is turned off while the range position cannot be detected, and, after that, the power source is switched to on, it is possible to, by setting the range position of the shift member as the range position of the vehicle, prevent disagreement between the range position of the vehicle and the range position of the shift member.

Thus, according to the present invention, even when a state in which a range position cannot be identified occurs due to the range position being set between ranges or due to a fault, it is possible to, by causing the notification means to operate irrespective of an operation by the driver if the state in which the range position cannot be detected continues for a predetermined time or more, enable a driver to recognize that the shift operation has not been accepted and avoid a vehicle from entering a different travel state.

### BRIEF DESCRIPTION OF THE DRAWINGS

FIG. 1 is a diagram showing an overview of a control path system of a shift apparatus of the present invention on a vehicle;

FIG. 2 is a diagram showing arrangement of the shift apparatus in front of a driver according to the present invention;

FIG. 3 is a block diagram showing the control path system for the shift apparatus of the present invention;

FIG. 4 is an overview configuration diagram of the shift apparatus of the present invention; and

FIG. 5 is a flowchart of control of operation of notification means by a control unit of the present invention.

### DETAILED DESCRIPTION OF THE INVENTION

An embodiment of the present invention will be described in detail with reference to drawings.

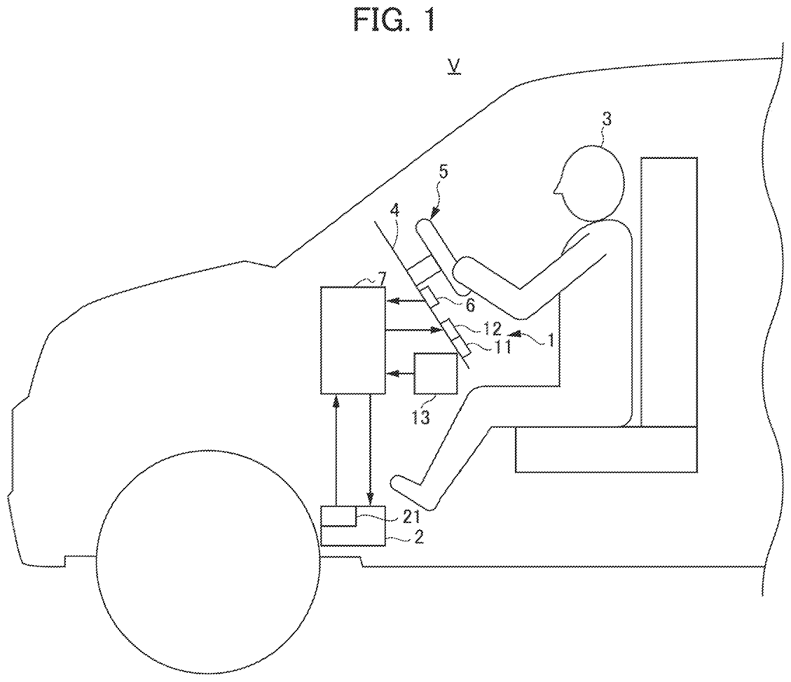

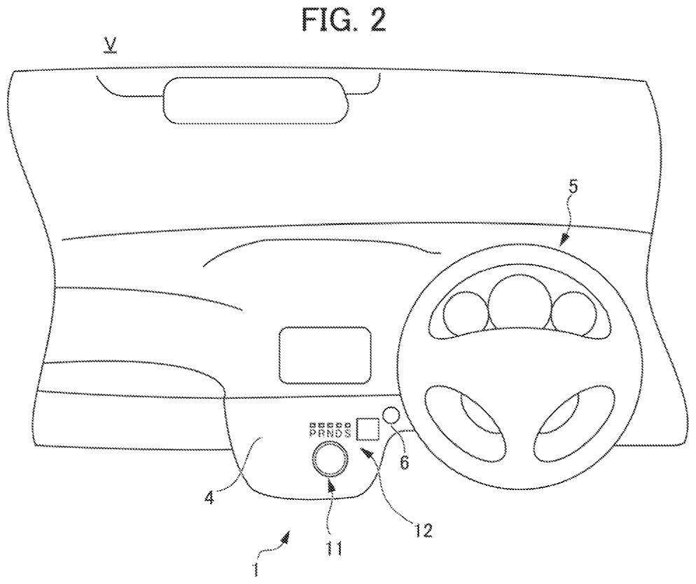

A shift apparatus 1 of a vehicle V is an apparatus for a driver 3 of the vehicle V to select a range position of a transmission 2 and is provided with a shift member 11, a display unit 12 and range position detection means 13 as shown in FIGS. 1 and 2. The shift member 11 is an operation member for the driver 3 to perform a rotation operation at the time of selecting a range position and is arranged on a display panel 4 in front of the driver 3 and below the left side of a travel operation handle 5. The display unit 12 indicates a selected range position and displays a warning message or the like at the time of abnormality, and is arranged on the upper right side of the shift member 11 on the display panel 4. The range position detection means 13 detects a range position selected by the shift member 11 and is provided behind the shift member 11. Behind the travel operation handle 5, a power switch 6 of the vehicle V is provided. In the vehicle V, a control unit 7 is provided which receives signals from detectors and the like, performs signal processing by a processing device such as a CPU and transmits the signals that have been processed to devices.

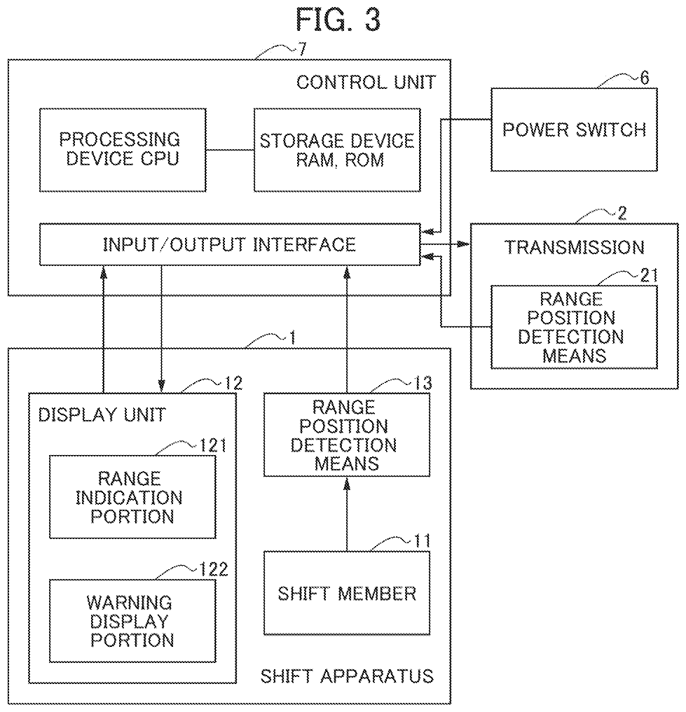

FIG. 3 is a block diagram showing sending and receiving of signals between the control unit 7 and each detector and each device in the vehicle V. The control unit 7 is configured with a processing device (a CPU) configured with a microcomputer or the like, a storage device configured with a ROM, a RAM and the like, an input/output interface and other equipment such as a timer. The control unit 7 receives signals from the range position detection means 13 of the shift apparatus 1, the power switch 6 of the vehicle V and vehicle (transmission) range position detection means 21 of the transmission 2, and transmits the signals appropriately signal-processed by the CPU to the display unit 12 of the shift apparatus 1 and the transmission 2.

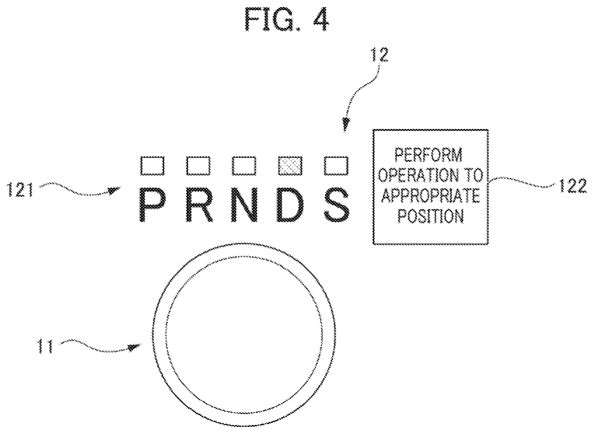

As shown in FIG. 4, the shift member 11 of the shift apparatus 1 is a rotation operation member configured with a dial-type cylindrical knob member. The display unit 12 is arranged above the shift member 11 and is provided with a range position indication portion 121 where a position of a shift range switched to is indicated, and a warning display portion 122 which, when an abnormality such as a fault occurs in the shift apparatus 1, notifies occurrence of the abnormality, a method for measures and the like by a message.

Ranges displayed on the range position indication portion 121 include, in addition to a P (parking) range at the time of parking, an R (reverse) range for causing the vehicle V to reversely travel, an N (neutral) range for blocking transmission of driving force and a D (drive) range for causing the vehicle V to travel forward, an L (low (1st speed)) range, a 2 (second) range, an S (sports mode) range, a B (regenerative braking) range and the like. The shift apparatus 1 of the present embodiment has the P, R, N, D and S ranges, and the characters indicating the ranges are arranged on the range position indication portion 121 in order of P, R, N, D and S from the left side. Above each character, a rectangular frame that blinks when the character is selected is provided.

The warning display portion 122 is arranged on the right side of the range position indication portion 121 and configured with a message display device configured with an LED and the like. When an abnormality is recognized in the shift apparatus 1, the warning display portion 122 notifies the driver 3 of the occurrence of the abnormality and a method for measures to solve the abnormal state. In the present embodiment, for example, when the range position detection means 13 of the shift apparatus 1 cannot detect a range position for a predetermined time or more, a warning message, “Perform an operation to specify an appropriate position” is displayed. Note that, in this case, a warning sound is generated from a speaker not shown at the same time when the warning message is displayed. Thereby, the driver 3 can recognize that an operation by the shift member 11 of the shift apparatus 1 has not been accepted due to a fault of the vehicle V or the like, and it is possible to prevent the vehicle V from continuing travel in a different travel state.

The control unit 7 receives a signal of a range position of the transmission 2 (a range position of the vehicle V) from the range position detection means 21 of the transmission 2. The warning message display and the abnormality occurrence notification by the warning sound in the case of occurrence of an abnormality are continued as far as a range position detected by the range position detection means 13 of the shift apparatus 1 and a range position detected by the range position detection means 21 of the transmission 2 (the range position of the vehicle V) are different from each other. When the range position detected by the range position detection means 13 of the shift apparatus 1 and the range position detected by the range position detection means 21 of the transmission 2 (the range position of the vehicle V) agree with each other, the control unit 7 causes the warning message display and the abnormality occurrence notification by the warning sound to end. Thereby, it is possible to prevent unnecessary abnormality occurrence notification after the range position of the vehicle V and the range position detected by the range position detection means 13 of the shift apparatus 1 agree with each other.

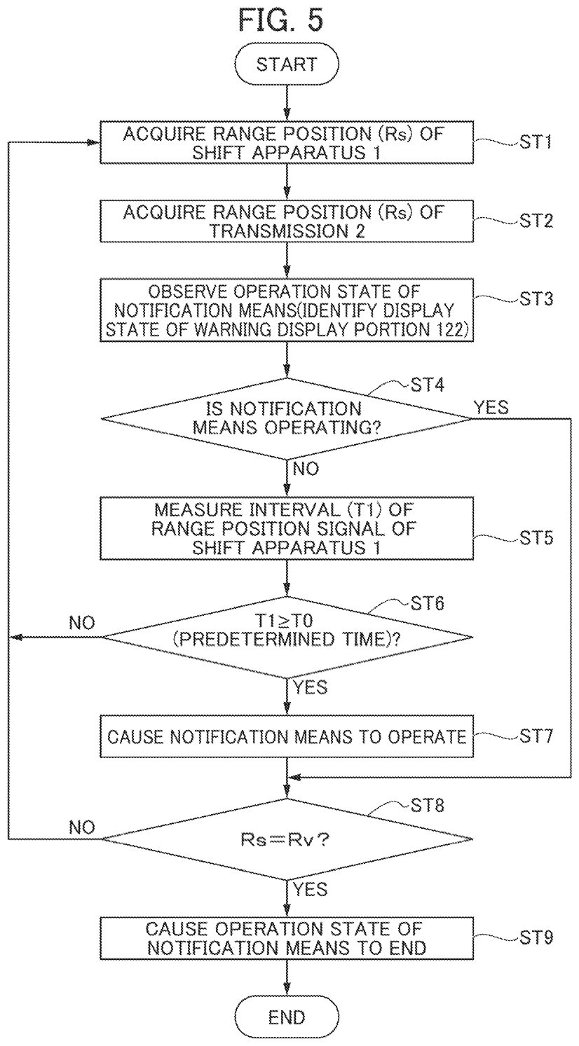

Next, with reference to the flow chart of FIG. 5, a description will be made on the control of abnormality occurrence notification by the control unit 7, that is, the control of operation of notification means configured to warn message display on the warning display portion 122 of the shift apparatus 1 and generation of warning sound.

As shown in FIG. 5, first, the control unit 7 receives a range position signal from the range position detection means 13 of the shift apparatus 1 and acquires a range position (Rs) (step ST1). Further, the control unit 7 receives a range position signal of the vehicle V from the range position detection means 21 of the transmission 2 of the vehicle V and acquires a range position (Rv) (step ST2). Further, the control unit 7 receives a display state signal from the warning display portion 122 of the shift apparatus 1 and observes a display state of the warning display portion 122, and the notification means identifies an operation state (step ST3).

Next, the control unit 7 judges whether or not the notification means has operated, and the display state of the warning display portion 122 is a state in which the warning message is displayed (step ST4). If a result of the judgment is YES, that is, the display state of the warning display portion 122 is the state in which the warning message is displayed, the flow proceeds to step ST8. If the result of the judgment is NO, that is, the display state of the warning display portion 122 is not the state in which the warning message is displayed, and an abnormality has not occurred, the flow proceeds to step ST5.

At step ST5, the control unit 7 measures a time interval (T1) to receive the range position signal from the range position detection means 13 of the shift apparatus 1 using the timer (step ST5). Then, next, the control unit 7 judges whether the interval (T1) to receive the range position signal sent from the range position detection means 13, which has been measured at step ST5, is larger than a predetermined time (T0) or not (step ST6). If a result of the judgment is YES, that is, the interval (T1) to receive the range position signal sent from the range position detection means 13 is larger than the predetermined time (T0), the flow proceeds to step ST7. If the result of the judgment is NO, that is, the interval (T1) to receive the range position signal sent from the range position detection means 13 is smaller than the predetermined time (T0), the flow returns to step ST1.

At step ST7, the control unit 7 causes the notification means to operate to cause the warning message to be displayed on the warning display portion 122 of the shift apparatus 1 and cause the warning sound to be generated from the speaker (step ST7). This means that, when it is judged at the previous step ST6 that the interval (T1) to receive the range position signal sent from the range position detection means 13 is larger than the predetermined time (T0), that is, a state in which the range position detection means 13 of the shift apparatus 1 cannot detect a range position continues for a predetermined time or more, the notification means is caused to operate to notify the driver 3 of the abnormal state.

Next, the control unit 7 judges whether the range position (Rs) of the shift apparatus 1 acquired at step ST1 and the range position (Rv) of the transmission 2 (the vehicle V) acquired at step ST2 agree with each other or not (step ST8). If a result of the judgment is YES, that is, the range position (Rs) of the shift apparatus 1 and the range position (Rv) of the transmission 2 (the vehicle V) agree with each other, the flow proceeds to step ST9. If the result of the judgment is NO, that is, the range position (Rs) of the shift apparatus 1 and the range position (Rv) of the transmission 2 (the vehicle V) are different from each other, the flow returns to step ST1.

At step ST9, the control unit 7 causes the warning message display on the warning display portion 122 of the shift apparatus 1 and the generation of the warning sound to end (to be released) (step ST9). This means that, if it is judged at the previous step ST8 that the range position (Rs) of the shift apparatus 1 and the range position (Rv) of the transmission 2 (the vehicle V) agree with each other, the operation of the notification means in the shift apparatus 1 is ended (released). On the other hand, if it is judged at the previous step ST8 that the range position (Rs) of the shift apparatus 1 and the range position (Rv) of the transmission 2 (the vehicle V) are different from each other, the flow returns to step ST1. At step ST4 after steps ST2 and ST3, since the warning display portion 122 of the shift apparatus 1 is in the warning message display state, a result of the judgment at step ST4 is YES, and the flow proceeds step ST8. Unless a result of the judgment of step ST8 is YES, that is, until it is judged that the range position (Rs) of the shift apparatus 1 and the range position (Rv) of the transmission 2 (the vehicle V) agree with each other, a loop of transition in order of step ST8, step ST1, step ST2, step ST3, step 4 and step ST8 is repeated, and the operation of the notification means in the shift apparatus 1 is continued.

Next, a description will be made on control of operation of the notification means by the control unit 7 immediately after the power source of the vehicle V is turned on, that is, control of display of the warning message on the warning display portion 122 of the shift apparatus 1 and generation of the warning sound by the control unit 7.

In one aspect of the present invention, when the power switch 6 of the vehicle V is turned on from off, the control of operation of the notification means performed by the control unit 7, which has been described above, is performed after the control unit 7 receives the range position detection signal from the range position detection means 13 first. Before the control unit 7 receives the range position detection signal from the range position detection means 13 of the shift apparatus 1 first, operation of the notification means is not performed even if the state in which the range position detection means 13 of the shift apparatus 1 cannot detect a range position continues for the predetermined time or more. When the power source is turned on from off by the power switch 6, there is a possibility that the range position of the shift apparatus 1 cannot be identified immediately after the power source of the vehicle V is turned on from off because of influence of an operation of the shift apparatus 1 having been performed while the vehicle power source was off or influence of the battery of the vehicle V having been removed. If the warning message is displayed on the warning display portion 122 of the shift apparatus 1 and the warning sound is generated in such a case, it is annoying to the driver 3. Therefore, when the power source of the vehicle V is switched to on from off, the control to cause the notification means to operate is restarted after a predetermined range position of the shift apparatus 1 is set.

In another aspect of the present invention, when the power switch 6 of the vehicle V is switched to on from off, the range position of the shift apparatus 1 is adopted as the range position of the vehicle V (the range position of the transmission 2). Thereby, even in a case where the power source of the vehicle V is turned off while the range position of the shift apparatus 1 cannot be detected and is switched to on after that, it is possible to prevent the range position of the shift apparatus 1 and the range position of the vehicle V (the transmission 2) after the power source is switched to on from off from being different from each other.

The present invention has been described above using an embodiment. The present invention, however, is not limited to the embodiment at all, and it goes without saying that the present invention can be practiced in various embodiments within a range not departing from the spirit of the present invention.

### EXPLANATION OF REFERENCE NUMERALS

1: Shift apparatus

11: Shift member (rotation operation member) of shift apparatus

12: Display unit of shift apparatus

121: Range position indication portion

122: Warning display portion

13: Range position detection means of shift apparatus

2: Transmission

21: Range position detection means of transmission

3: Driver

4: Display panel of vehicle

5: Travel operation handle

6: Power switch of vehicle

7: Control unit

What is claimed is:

1. A shift apparatus of a vehicle, the shift apparatus comprising:
a shift member that is enabled to switch to any of a plurality of predetermined ranges by performing a rotation operation of a dial-type operation member; and
range position detection means configured to detect a predetermined range position of the shift member; wherein
if a state in which the range position cannot be detected continues for a predetermined time or more, notification means is operated irrespective of the rotation operation.

2. The shift apparatus according to claim 1, wherein, if, when a power source of a vehicle is switched to on from off first, the state in which a range position cannot be detected continues for the predetermined time or more after the predetermined range position is detected, the notification means is operated irrespective of the rotation operation.

3. The shift apparatus according to claim 1, wherein the notification means operates until a range position of the vehicle and a range position of the shift member become the same.

4. The shift apparatus according to claim 1, wherein, when the power source of the vehicle is turned on from off, the range position of the shift member is set as the range position of the vehicle.
